(19) United States
(12) Patent Application Publication
(10) Pub. No.: US 2026/0164490 A1
(43) Pub. Date: Jun. 11, 2026

(54) Enabling WiFi-Cellular Interworking With Virtualized WiFi Access Points

(71) Applicant: AT&T Intellectual Property I, L.P., Atlanta, GA (US)

(72) Inventors: Yupeng Jia, South Pasadena, CA (US); Hongyan Lei, Plano, TX (US); Feng Wang, Austin, TX (US)

(73) Assignee: AT&T Intellectual Property I, L.P., Atlanta, GA (US)

(21) Appl. No.: 18/975,227

(22) Filed: Dec. 10, 2024

(51) Int. Cl. H04W 76/16; H04W 84/04; H04W 84/12; H04W 88/06

(52) U.S. Cl. CPC H04W 76/16; H04W 84/042; H04W 84/12; H04W 88/06

(57) ABSTRACT

Enabling WiFi-cellular interworking with virtualized WiFi access points can include receiving, via a fronthaul of a cellular network and from a customer premises equipment, WiFi data generated by the customer premises equipment based on WiFi signals received at the customer premises equipment; and determining, based on a network architecture file, a WiFi controller that is configured to control the customer premises equipment, where the WiFi controller is not located at the customer premises equipment. The WiFi data can be relayed to the WiFi controller, where the WiFi controller performs an operation on the WiFi data and creates another instance of WiFi data. The other instance of WiFi data can be received from the WiFi controller and provided to the customer premises equipment. The customer premises equipment can transmit WiFi signals at the customer premises equipment based on the WiFi data.

### BACKGROUND

Some current enterprise and operator wireless local area networks (“WLANs”) may require specialized devices including hardware and software that can be located on-site for a connected location such as an office, home, or the like. Thus, these approaches can require on-site device management, configuration, upgrades, and the like. As such, expanding or upgrading WiFi capabilities at a customer site may involve on-site hardware and/or software installation, device swapping, device reconfiguration, and/or other on-site tasks that may make device management and/or device upgrades difficult to scale efficiently.

### SUMMARY

The present disclosure is directed to enabling WiFi-cellular interworking with virtualized WiFi access points. A customer premises equipment can be located at a location to create a connected environment. The customer premises equipment can include WiFi hardware and a radio unit controller, but the customer premises equipment does not include a WiFi controller in various embodiments. The radio unit controller can be configured to translate WiFi signals obtained by the WiFi hardware into digital representations of the WiFi signals, e.g., WiFi data. The radio unit controller also can be configured to determine a network architecture for the cellular network that the customer premises equipment operates as a part of. In some embodiments, the customer premises equipment can store the network architecture as a network map, as part of configurations or settings, and/or can access a network architecture from time to time (e.g., at a service, device, or data storage location). It should be understood that this example embodiment is illustrative, and therefore should not be construed as being limiting in any way.

The customer premises equipment can determine, based on the network architecture, if the WiFi data is to be transmitted to a distributed unit, a centralized unit, and/or to a service such as a WiFi controller operating on a server computer. Based on the determined architecture, the customer premises equipment can transmit the WiFi data via one or more of a fronthaul, midhaul, and/or backhaul of the cellular network, as well as via the Internet or other network connection. The WiFi data can be transmitted to the distributed unit in some embodiments, whereby the distributed unit can control communications of the customer premises equipment and perform operations on the WiFi data via an onboard WiFi controller. It should be understood that this example embodiment is illustrative, and therefore should not be construed as being limiting in any way.

In some other embodiments, the customer premises equipment can transmit the WiFi data to the centralized unit, whereby the centralized unit can control communications of the customer premises equipment and perform operations on the WiFi data via an onboard WiFi controller. It should be understood that this example embodiment is illustrative, and therefore should not be construed as being limiting in any way. In yet other embodiments of the concepts and technologies disclosed herein, the customer premises equipment can transmit the WiFi data to a server computer, and the server computer can control communications of the customer premises equipment and perform operations on the WiFi data via a WiFi controller operated and/or executed thereon. As such, a customer premises equipment can be configured to operate as a radio unit via remote control by one or more of the distributed unit, the centralized unit, and/or a server computer. Embodiments of the concepts and technologies disclosed herein can be used to offload cellular traffic to WiFi, where the WiFi can be controlled by devices on the cellular network. It should be understood that this example embodiment is illustrative, and therefore should not be construed as being limiting in any way.

According to one aspect of the concepts and technologies disclosed herein, a system is disclosed. The system can include a processor and a memory. The memory can store computer-executable instructions that, when executed by the processor, cause the processor to perform operations. The operations can include receiving, via a fronthaul of a cellular network and from a customer premises equipment including a WiFi transceiver, WiFi data generated by the customer premises equipment based on WiFi signals received at the customer premises equipment; and determining, based on a network architecture file, a WiFi controller that can be configured to control the customer premises equipment, where the WiFi controller is not located at the customer premises equipment. The operations further can include relaying the WiFi data to the WiFi controller. The WiFi controller can perform an operation on the WiFi data and create another instance of WiFi data. The operations further can include receiving, from the WiFi controller, the other instance of WiFi data; and providing, to the customer premises equipment, the other instance of WiFi data. The customer premises equipment can transmit WiFi signals at the customer premises equipment based on the WiFi data.

In some embodiments, the WiFi data can be received at a distributed unit of the cellular network, wherein the WiFi controller can be executed by the distributed unit, and wherein the distributed unit can manage operations of the customer premises equipment. In some embodiments, receiving the WiFi data further can include receiving the WiFi data via a midhaul of the cellular network. The WiFi data can be received at a centralized unit of the cellular network, the WiFi data can be relayed to the centralized unit of the cellular network by a distributed unit of the cellular network, and the WiFi controller can be executed by the centralized unit.

In some embodiments, receiving the WiFi data further can include receiving the WiFi data via a midhaul of the cellular network, a backhaul of the cellular network, and a wide area network. The WiFi data can be received at a server computer operating on the wide area network, the WiFi data can be relayed to the server computer via a distributed unit of the cellular network and via a centralized unit of the cellular network, and the WiFi controller can be executed by the server computer. In some embodiments, the backhaul can be configured to use a 3rd generation partnership project (“3GPP”) standard for trusted access between the centralized location and the server computer. In some embodiments, an interface of the fronthaul can be enhanced to support WiFi access, and a further interface of the midhaul can be enhanced to support the WiFi access. In some embodiments, the customer premises equipment can execute a radio unit controller that can translate the WiFi signals into the WiFi data and the other instance of WiFi data into the other instance of WiFi signals.

According to another aspect of the concepts and technologies disclosed herein, a method is disclosed. The method can include receiving, at a computer including a processor, via a fronthaul of a cellular network, and from a customer premises equipment that includes a WiFi transceiver, WiFi data generated by the customer premises equipment based on WiFi signals received at the customer premises equipment; and determining, by the processor and based on a network architecture file, a WiFi controller that can be configured to control the customer premises equipment, where the WiFi controller is not located at the customer premises equipment. The method further can include relaying, by the processor and to the WiFi controller, the WiFi data. The WiFi controller can perform an operation on the WiFi data and create another instance of WiFi data. The method further can include receiving, by the processor and from the WiFi controller, the other instance of WiFi data; and providing, by the processor and to the customer premises equipment, the other instance of WiFi data. The customer premises equipment can transmit WiFi signals at the customer premises equipment based on the WiFi data.

In some embodiments, the WiFi data can be received at a distributed unit of the cellular network, wherein the WiFi controller can be executed by the distributed unit, and wherein the distributed unit can manage operations of the customer premises equipment. In some embodiments, receiving the WiFi data further can include receiving the WiFi data via a midhaul of the cellular network. The WiFi data can be received at a centralized unit of the cellular network, the WiFi data can be relayed to the centralized unit of the cellular network by a distributed unit of the cellular network, and the WiFi controller can be executed by the centralized unit.

In some embodiments, receiving the WiFi data further can include receiving the WiFi data via a midhaul of the cellular network, a backhaul of the cellular network, and a wide area network. The WiFi data can be received at a server computer operating on the wide area network, the WiFi data can be relayed to the server computer via a distributed unit of the cellular network and via a centralized unit of the cellular network, and the WiFi controller can be executed by the server computer. In some embodiments, the backhaul can be configured to use a 3rd generation partnership project (“3GPP”) standard for trusted access between the centralized location and the server computer. In some embodiments, an interface of the fronthaul can be enhanced to support WiFi access, and a further interface of the midhaul can be enhanced to support the WiFi access. In some embodiments, the customer premises equipment can execute a radio unit controller that can translate the WiFi signals into the WiFi data and the other instance of WiFi data into the other instance of WiFi signals.

According to yet another aspect of the concepts and technologies disclosed herein, a computer storage medium is disclosed. The computer storage medium can store computer-executable instructions that, when executed by a processor, cause the processor to perform operations. The operations can include receiving, via a fronthaul of a cellular network and from a customer premises equipment including a WiFi transceiver, WiFi data generated by the customer premises equipment based on WiFi signals received at the customer premises equipment; and determining, based on a network architecture file, a WiFi controller that can be configured to control the customer premises equipment, where the WiFi controller is not located at the customer premises equipment. The operations further can include relaying the WiFi data to the WiFi controller. The WiFi controller can perform an operation on the WiFi data and create another instance of WiFi data. The operations further can include receiving, from the WiFi controller, the other instance of WiFi data; and providing, to the customer premises equipment, the other instance of WiFi data. The customer premises equipment can transmit WiFi signals at the customer premises equipment based on the WiFi data.

In some embodiments, the WiFi data can be received at a distributed unit of the cellular network, wherein the WiFi controller can be executed by the distributed unit, and wherein the distributed unit can manage operations of the customer premises equipment. In some embodiments, receiving the WiFi data further can include receiving the WiFi data via a midhaul of the cellular network. The WiFi data can be received at a centralized unit of the cellular network, the WiFi data can be relayed to the centralized unit of the cellular network by a distributed unit of the cellular network, and the WiFi controller can be executed by the centralized unit.

In some embodiments, receiving the WiFi data further can include receiving the WiFi data via a midhaul of the cellular network, a backhaul of the cellular network, and a wide area network. The WiFi data can be received at a server computer operating on the wide area network, the WiFi data can be relayed to the server computer via a distributed unit of the cellular network and via a centralized unit of the cellular network, and the WiFi controller can be executed by the server computer. In some embodiments, the backhaul can be configured to use a 3rd generation partnership project (“3GPP”) standard for trusted access between the centralized location and the server computer. In some embodiments, an interface of the fronthaul can be enhanced to support WiFi access, and a further interface of the midhaul can be enhanced to support the WiFi access. In some embodiments, the customer premises equipment can execute a radio unit controller that can translate the WiFi signals into the WiFi data and the other instance of WiFi data into the other instance of WiFi signals.

Other systems, methods, and/or computer program products according to embodiments will be or become apparent to one with skill in the art upon review of the following drawings and detailed description. It is intended that all such additional systems, methods, and/or computer program products be included within this description and be within the scope of this disclosure.

### BRIEF DESCRIPTION OF THE DRAWINGS

FIG. 1 is a system diagram illustrating an illustrative operating environment for various embodiments of the concepts and technologies described herein.

FIG. 2 is a flow diagram showing aspects of a method for enabling WiFi-cellular interworking with virtualized WiFi access points, according to an illustrative embodiment of the concepts and technologies described herein.

FIG. 3 is a flow diagram showing aspects of a method for enabling WiFi-cellular interworking with virtualized WiFi access points, according to another illustrative embodiment of the concepts and technologies described herein.

FIG. 4 is a flow diagram showing aspects of a method for enabling WiFi-cellular interworking with virtualized WiFi access points, according to another illustrative embodiment of the concepts and technologies described herein.

FIG. 5 schematically illustrates a network, according to an illustrative embodiment of the concepts and technologies described herein.

FIG. 6 is a block diagram illustrating an example computer system configured to enable WiFi-cellular interworking with virtualized WiFi access points, according to some illustrative embodiments of the concepts and technologies described herein.

FIG. 7 is a diagram illustrating a computing environment capable of implementing aspects of the concepts and technologies disclosed herein, according to some illustrative embodiments of the concepts and technologies described herein.

### DETAILED DESCRIPTION

The following detailed description is directed to enabling WiFi-cellular interworking with virtualized WiFi access points. A customer premises equipment can be located at a location to create a connected environment. The customer premises equipment can include WiFi hardware and a radio unit controller, but the customer premises equipment does not include a WiFi controller in various embodiments. The radio unit controller can be configured to translate WiFi signals obtained by the WiFi hardware into digital representations of the WiFi signals, e.g., WiFi data. The radio unit controller also can be configured to determine a network architecture for the cellular network that the customer premises equipment operates as a part of. In some embodiments, the customer premises equipment can store the network architecture as a network map, as part of configurations or settings, and/or can access a network architecture from time to time (e.g., at a service, device, or data storage location). It should be understood that this example embodiment is illustrative, and therefore should not be construed as being limiting in any way.

The customer premises equipment can determine, based on the network architecture, if the WiFi data is to be transmitted to a distributed unit, a centralized unit, and/or to a service such as a WiFi controller operating on a server computer. Based on the determined architecture, the customer premises equipment can transmit the WiFi data via one or more of a fronthaul, midhaul, and/or backhaul of the cellular network, as well as via the Internet or other network connection. The WiFi data can be transmitted to the distributed unit in some embodiments, whereby the distributed unit can control communications of the customer premises equipment and perform operations on the WiFi data via an onboard WiFi controller. It should be understood that this example embodiment is illustrative, and therefore should not be construed as being limiting in any way.

In some other embodiments, the customer premises equipment can transmit the WiFi data to the centralized unit, whereby the centralized unit can control communications of the customer premises equipment and perform operations on the WiFi data via an onboard WiFi controller. It should be understood that this example embodiment is illustrative, and therefore should not be construed as being limiting in any way. In yet other embodiments of the concepts and technologies disclosed herein, the customer premises equipment can transmit the WiFi data to a server computer, and the server computer can control communications of the customer premises equipment and perform operations on the WiFi data via a WiFi controller operated and/or executed thereon. As such, a customer premises equipment can be configured to operate as a radio unit via remote control by one or more of the distributed unit, the centralized unit, and/or a server computer. Embodiments of the concepts and technologies disclosed herein can be used to offload cellular traffic to WiFi, where the WiFi can be controlled by devices on the cellular network. It should be understood that this example embodiment is illustrative, and therefore should not be construed as being limiting in any way.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

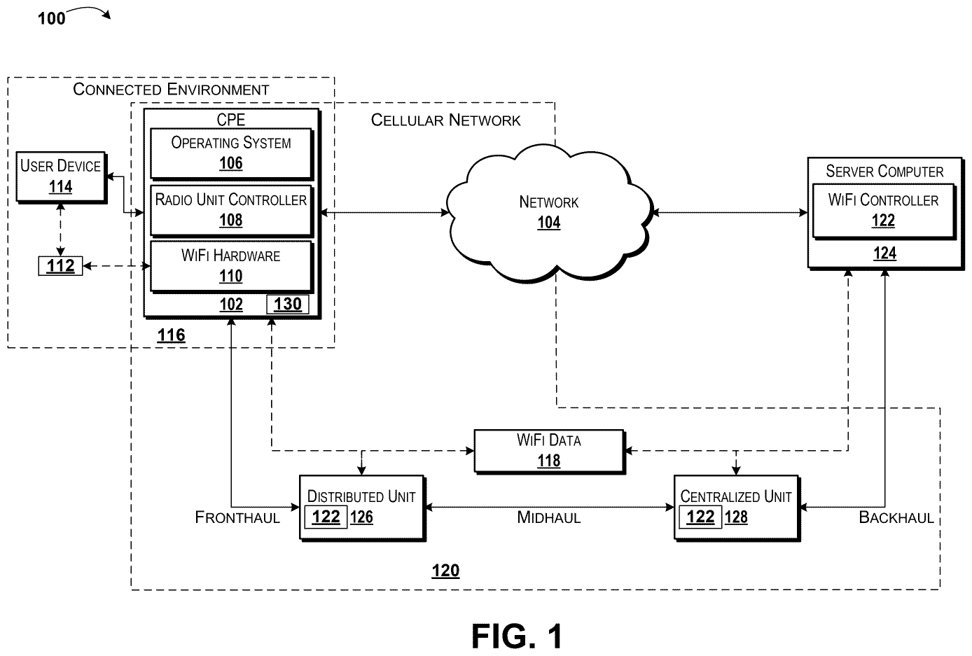

Referring now to FIG. 1, aspects of an operating environment 100 for various embodiments of the concepts and technologies disclosed herein for enabling WiFi-cellular interworking with virtualized WiFi access points will be described, according to an illustrative embodiment. The operating environment 100 shown in FIG. 1 includes a customer premises equipment 102. The customer premises equipment 102 can operate in communication with and/or as part of a communications network (“network”) 104, though this is not necessarily the case.

According to various embodiments, the functionality of the customer premises equipment 102 may be provided by a home or office gateway device, a set-top box (“STB”) or set-top unit (“STU”), a home or office router, other computing systems, or the like. It should be understood that the functionality of the customer premises equipment 102 may be provided by a single device, by two or more similar devices, and/or by two or more dissimilar devices. For purposes of describing the concepts and technologies disclosed herein, the customer premises equipment 102 is described herein as a home gateway device for providing Internet connectivity for a home or other location. It should be understood that this embodiment is illustrative, and should not be construed as being limiting in any way.

The customer premises equipment 102 can execute an operating system 106 and one or more application programs such as, for example, a radio unit controller 108. The operating system 106 can include a computer program that can control the operation of the customer premises equipment 102. The radio unit controller 108 can include an executable program that can be configured to execute on top of the operating system 106 to provide various functions as illustrated and described herein for providing a radio unit (“RU”) at the customer premises equipment 102. Some functions of the radio unit controller 108 will be explained in more detail hereinbelow after introducing some additional components of the operating environment 100.

The customer premises equipment 102 also can include WiFi hardware 110. The WiFi hardware 110 can include, for example, one or more WiFi transmitters, receivers, or transceivers; one or more WiFi antennas; one or more signal amplifiers; one or more signal repeaters; and/or other hardware for obtaining WiFi signals 112 and/or performing operations on the WiFi signals 112 (including analog operations, translating analog signals to digital signals and/or data, and/or digital operations). In some embodiments, for example, one or more devices such as a user device 114 can communicate with the customer premises equipment 102, thereby creating a connected environment 116 such as a home, office, business, other location, or the like. The WiFi hardware 110 can be used to obtain WiFi signals 112 from devices such as the user device 114. The WiFi hardware 110 also can be used to perform operations on the WiFi signals 112 (e.g., applying repeaters, amplifiers, and the like, as well as to send the WiFi signals 112 and/or representations thereof (e.g., WiFi data 118 that represents the WiFi signals 112) to one or more downstream devices and/or entities operating in a cellular network and/or a transport layer of the cellular network and/or a radio access network (“RAN”) of the cellular network (hereinafter collectively and/or generically referred to as the “cellular network”) 120 and/or other portions of the network 104. In the claims, the phrase “cellular network” is used to refer to the cellular network core and the transport layer and radio access network thereof, as will be explained in more detail herein. It should be understood that this example embodiment is illustrative, and therefore should not be construed as being limiting in any way.

In various embodiments of the concepts and technologies disclosed herein, the customer premises equipment 102 can operate as a radio unit (“RU”) or the like, obtaining WiFi signals 112 using the WiFi hardware 110 and converting the WiFi signals 112 into digital data (the WiFi data 118 illustrated and described herein) before passing the WiFi data 118 to an offboard WiFi controller 122. According to various embodiments of the concepts and technologies disclosed herein, the radio unit controller 108 can be configured to convert the WiFi signals 112 obtained via the WiFi hardware 110 into digital data (e.g., the WiFi data 118) and to control transmission of the WiFi data 118 to one or more other entities on the cellular network 120 for operations on the WiFi data 118. Thus, it should be understood that in various embodiments of the concepts and technologies disclosed herein, the customer premises equipment 102 does not include a WiFi controller 122 or anything equivalent thereto, and the WiFi controller 122 is instead located in an offboard (and in various embodiments offsite) computing device. In particular, the operating environment 100 illustrated and described in FIG. 1 can operate as an Open Radio Access Network (O-RAN), whereby the WiFi signals 112 obtained by the WiFi hardware 110 of the customer premises equipment 102 are sent to one or more other entities on the cellular network 120 for operations on the WiFi data 118. It should be understood that this example embodiment is illustrative, and therefore should not be construed as being limiting in any way.

According to various embodiments of the concepts and technologies disclosed herein, the cellular network 120 can include, in various embodiments, one or more instances of customer premises equipment 102, which can effectively operate as radio units for the cellular network 120 in some embodiments. It should be understood that this example embodiment is illustrative, and therefore should not be construed as being limiting in any way. The customer premises equipment 102 can, as noted above, convert the WiFi signals 112 obtained by the WiFi hardware 110 into the WiFi data 118, and pass the WiFi data 118 to one or more other elements operating on the cellular network 120. In some embodiments, for example, the customer premises equipment 102 can transmit the WiFi data 118, via a cellular fronthaul (labeled “fronthaul” in FIG. 1), to a distributed unit 126 that can operate on the cellular network 120. The fronthaul can include a fiber-based connection or other broadband connection between the distributed unit 126 and the customer premises equipment 102. As is also generally understood, the fronthaul can include one or more interfaces (e.g., fronthaul interfaces) between the distributed unit 126 and the customer premises equipment 102. According to various embodiments of the concepts and technologies disclosed herein, these fronthaul interfaces can be configured as O-RAN interfaces to allow leveraging of cellular network core security protocols and trusted relationships between entities on the cellular network 120. It should be understood that this example embodiment is illustrative, and therefore should not be construed as being limiting in any way.

As is generally understood, the distributed unit 126 can be configured to prepare WiFi data 118 for transmission (e.g., preparing WiFi data 118 in response to or after performing operations on WiFi data 118 that was received from the customer premises equipment 102), controlling communications of the customer premises equipment 102 (e.g., directly managing data communications of the customer premises equipment 102 including, for example, translating digital data such as the WiFi data 118 into WiFi signals 112 for transmission by the customer premises equipment 102), and other data optimization management functions. According to various embodiments of the concepts and technologies disclosed herein, the distributed unit 126 can operate as a building hub, a neighborhood hub, and/or other hub for the cellular network 120. It should be understood that this example embodiment is illustrative, and therefore should not be construed as being limiting in any way.

According to various embodiments of the concepts and technologies disclosed herein, the distributed unit 126 can include hardware and software for providing the network hub. The software can include, in various embodiments, the WiFi controller 122. Thus, as noted above, the customer premises equipment 102 does not include a WiFi controller 122 onboard and/or onsite, and instead can be managed in some embodiments by the distributed unit 126 via the WiFi controller 122 located thereon and via the fronthaul of the cellular network 120. It should be understood that this example embodiment is illustrative, and therefore should not be construed as being limiting in any way.

In some other embodiments (and/or in conjunction with the embodiments using the distributed units 126), the customer premises equipment 102 can transmit the WiFi data 118, via the fronthaul and/or a cellular midhaul (labeled “midhaul” in FIG. 1), to a centralized unit 128 that can operate on the cellular network 120. The midhaul can include transport between one or more distributed units 126 of a cellular network 120 and one or more centralized units 128 of the cellular network 120. As is also generally understood, the midhaul can include one or more interfaces (e.g., midhaul interfaces) between the distributed unit 126 and the centralized unit 128. According to various embodiments of the concepts and technologies disclosed herein, these midhaul interfaces can be configured as O-RAN interfaces to allow leveraging of cellular network security protocols and trusted relationships between entities on the cellular network 120. It should be understood that this example embodiment is illustrative, and therefore should not be construed as being limiting in any way. In various embodiments of the concepts and technologies disclosed herein, the midhaul can include high-capacity fiber networks, microwave networks, and/or other mesh networks to provide reliable high-capacity connections between the distributed units 126 and the centralized units 128. It should be understood that this example embodiment is illustrative, and therefore should not be construed as being limiting in any way.

As is generally understood, the centralized unit 128 can be configured to oversee various high-level operations for the cellular network 120 such as, for example, network management, coordinating communications between the distributed units 126 and the radio units (in embodiments of the concepts and technologies disclosed herein, instances of customer premises equipment 102), and providing management of other functions in the service data adaptation protocol (“SDAP”) layer, the packet data convergence protocol (“PDCP”) layer, and/or the radio resource control (“RRC”) layer. In some embodiments of the concepts and technologies disclosed herein, the centralized unit 128 can be configured to operate and/or execute a WiFi controller 122.

Thus, the customer premises equipment 102 can be configured to send the WiFi data 118 to the centralized unit 128 (instead of and/or in addition to the distributed unit 126), and the centralized unit 128 can be configured, by execution of the WiFi controller 122, to prepare WiFi data 118 for transmission (e.g., preparing WiFi data 118 in response to or after performing operations on WiFi data 118 that was received from the customer premises equipment 102), controlling communications of the customer premises equipment 102 (e.g., directly managing data communications of the customer premises equipment 102 including, for example, translating digital data such as the WiFi data 118 into WiFi signals 112 for transmission by the customer premises equipment 102), and other data optimization management functions.

According to various embodiments of the concepts and technologies disclosed herein, the centralized unit 128 can operate as a multi-state centralized control unit, or the like. Thus, as noted above, in various embodiments of the concepts and technologies disclosed herein, the customer premises equipment 102 does not include a WiFi controller 122 onboard and/or onsite, and instead can be managed in some embodiments by the centralized unit 128 via the WiFi controller 122 located thereon and via the fronthaul and midhaul of the cellular network 120. It should be understood that this example embodiment is illustrative, and therefore should not be construed as being limiting in any way.

In yet other embodiments (and/or in conjunction with the embodiments using the distributed unit 126 and/or the centralized unit 128), the customer premises equipment 102 can be configured to transmit the WiFi data 118, via the fronthaul, midhaul, and/or a cellular backhaul (labeled “backhaul” in FIG. 1), to a service such as a WiFi controller 122, which can operate on a server computer 124 that is operating on and/or in communication with the cellular network 120. As is also generally understood, the backhaul can include one or more interfaces (e.g., backhaul interfaces) between the centralized unit 128 and other networks such as wide-area networks such as the Internet or corporate networks or the like. According to various embodiments of the concepts and technologies disclosed herein, these backhaul interfaces can be configured as O-RAN interfaces to allow leveraging of cellular network core security protocols and trusted relationships between entities on the cellular network 120. Furthermore, some embodiments of the concepts and technologies disclosed herein include using 3rd generation partnership project (“3GPP”) standards and/or protocols to provide trusted and secure connections between the cellular network 120 and other networks (e.g., a network on which the server computer 124 is operating). It should be understood that this example embodiment is illustrative, and therefore should not be construed as being limiting in any way.

Although the server computer 124 is illustrated in FIG. 1 as operating off the cellular network 120, it should be understood that this example is illustrative of some embodiments. In particular, in some embodiments of the concepts and technologies disclosed herein, the server computer 124 can operate on the cellular network 120. In some other embodiments, the server computer 124 can operate off the cellular network 120, for example as a virtualized service in a cloud computing environment in various embodiments. Thus, it should be understood that the illustrated embodiment is illustrative, and therefore should not be construed as being limiting in any way.

As is generally understood, the backhaul can include transport between a local access network such as a cellular network, a corporate intranet, and the like and the Internet or other networks. In various embodiments of the concepts and technologies disclosed herein, the backhaul can include high-capacity satellite connections, copper wire connections, fiber connections, microwave links, or the like, which can be configured to provide high-speed reliable connections. It should be understood that the above example connections are illustrative, and therefore should not be construed as being limiting in any way.

As such, it can be appreciated that the WiFi controller 122 can be operated in some embodiments as a service that manages communications of the customer premises equipment 102 remotely (e.g., via the fronthaul, midhaul, and/or backhaul of the cellular network 120 and/or via the Internet). Thus, in various embodiments of the concepts and technologies disclosed herein the customer premises equipment 102 can be configured to obtain WiFi signals 112 and to create WiFi data 118 based on the WiFi signals 112. The customer premises equipment 102 also can be configured to send the WiFi data 118 to the server computer 124 (instead of and/or in addition to the distributed unit 126 and/or the centralized unit 128), and the server computer 124 can be configured, e.g., by execution of the WiFi controller 122, to prepare WiFi data 118 for transmission (e.g., preparing WiFi data 118 in response to or after performing operations on WiFi data 118 that was received from the customer premises equipment 102), controlling communications of the customer premises equipment 102 (e.g., directly managing data communications of the customer premises equipment 102 including, for example, translating digital data such as the WiFi data 118 into WiFi signals 112 for transmission by the customer premises equipment 102), and performing other data optimization management functions. It should be understood that this example embodiment is illustrative, and therefore should not be construed as being limiting in any way.

Because various embodiments of the concepts and technologies disclosed herein move the WiFi controller 122 off the customer premises equipment 102, it should be understood that embodiments of the concepts and technologies disclosed herein can enable easier upgrades to the WiFi hardware 110 (and the customer premises equipment 102) and/or continuous updating of the WiFi controller 122 without having to access the connected environment, without having to replace the customer premises equipment 102, and the like. Thus, embodiments of the concepts and technologies disclosed herein can be used to reduce costs associated with providing customer premises equipment 102 to customers and/or updating hardware and/or software associated with the customer premises equipment 102. It should be understood that this example embodiment is illustrative, and therefore should not be construed as being limiting in any way.

In practice, a customer premises equipment 102 can be located at a location to create a connected environment 116. The customer premises equipment 102 can include WiFi hardware 110 and a radio unit controller 108. The radio unit controller 108 can be configured to translate WiFi signals 112 obtained by the WiFi hardware 110 into digital representations of the WiFi signals 112, e.g., WiFi data 118. The radio unit controller 108 also can be configured to determine a network architecture for the cellular network 120 that the customer premises equipment 102 operates as a part of. In some embodiments, the customer premises equipment 102 can store a network architecture file 130 that describes the network architecture. The network architecture file 130 can be stored as a network map, as part of configurations or settings, and/or as another type of file or data. In some embodiments, the customer premises equipment 102 can access a network architecture file 130 from time to time, where the network architecture file 130 can be stored remotely from the customer premises equipment 102 (e.g., at a service, device, or data storage location). It should be understood that this example embodiment is illustrative, and therefore should not be construed as being limiting in any way.

The customer premises equipment 102 can determine, based on the network architecture represented by the network architecture file 130, if the WiFi data 118 is to be transmitted to a distributed unit 126, a centralized unit 128, and/or to a service such as a WiFi controller 122 operating on a server computer 124. Based on the determined architecture, the customer premises equipment 102 can transmit the WiFi data 118 via one or more of a fronthaul, midhaul, and/or backhaul of the cellular network 120, as well as via the Internet or other network connection. The WiFi data 118 can be transmitted to the distributed unit 126 in some embodiments, whereby the distributed unit 126 can control communications of the customer premises equipment 102 and perform operations on the WiFi data 118 via an onboard WiFi controller 122. It should be understood that this example embodiment is illustrative, and therefore should not be construed as being limiting in any way.

In some other embodiments, the customer premises equipment 102 can transmit the WiFi data 118 to the centralized unit 128, whereby the centralized unit 128 can control communications of the customer premises equipment 102 and perform operations on the WiFi data 118 via an onboard WiFi controller 122. It should be understood that this example embodiment is illustrative, and therefore should not be construed as being limiting in any way. In yet other embodiments of the concepts and technologies disclosed herein, the customer premises equipment 102 can transmit the WiFi data 118 to a server computer 124, and the server computer 124 can control communications of the customer premises equipment 102 and perform operations on the WiFi data 118 via a WiFi controller 122 operated and/or executed thereon. As such, a customer premises equipment 102 can be configured to operate as a radio unit via remote control by one or more of the distributed unit 126, the centralized unit 128, and/or a server computer 124. It should be understood that this example embodiment is illustrative, and therefore should not be construed as being limiting in any way.

It can be appreciated that embodiments of the concepts and technologies disclosed herein can enable WiFi to be integrated into a fifth generation (“5G”) mobile network using an O-RAN architecture. In particular, some embodiments allow a WiFi access point (e.g., the customer premises equipment 102, which can provide WiFi access for devices at the connected environment 116) to connect directly to the distributed unit 126 by updating the fronthaul interface specification to support WiFi control (e.g., by the WiFi controller 122, which can be virtualized and hosted by the distributed unit 126 in some embodiments). It should be understood that this example embodiment is illustrative, and therefore should not be construed as being limiting in any way.

Similarly, some embodiments of the concepts and technologies disclosed herein can allow a WiFi access point (e.g., the customer premises equipment 102, which can provide WiFi access for devices at the connected environment 116) to connect directly to the centralized unit 128 by updating the midhaul interface specification to support WiFi control (e.g., by the WiFi controller 122, which can be virtualized and hosted by the centralized unit 128 in some embodiments). It should be understood that this example embodiment is illustrative, and therefore should not be construed as being limiting in any way. Furthermore, in some embodiments of the concepts and technologies disclosed herein, a WiFi access point such as the customer premises equipment 102 (which can provide WiFi access for devices at the connected environment 116) can be configured to connect directly to either and/or both of the distributed unit 126 and/or the centralized unit 128, where the decision of which unit to connect to for a particular customer premises equipment 102 can be based on, for example, distances from the customer premises equipment 102 to the distributed unit 126 and/or centralized unit 128, and the like. It should be understood that this example embodiment is illustrative, and therefore should not be construed as being limiting in any way.

In yet other embodiments, a WiFi access point (e.g., the customer premises equipment 102, which can provide WiFi access for devices at the connected environment 116) can be configured to connect directly to a WiFi controller 122, which can be hosted and/or operated on a wide-area network such as the Internet or the like, for example in a network cloud environment that can be accessed via a backhaul using one or more 3GPP standards and/or protocols. It should be understood that this example embodiment is illustrative, and therefore should not be construed as being limiting in any way.

These and other embodiments of the concepts and technologies disclosed herein can be used to provide various features and/or enhancements for WiFi access points and/or connectivity as illustrated and described herein. In particular, embodiments of the concepts and technologies disclosed herein can enable splitting of a WiFi access point (e.g., the customer premises equipment 102 illustrated and described herein) into two components. The customer premises equipment 102 can include the WiFi hardware 110 such as antennas and a WiFi transceiver (and other hardware such as repeaters and amplifiers), thereby functioning as a radio unit at the connected environment 116, while the WiFi controller 122 and/or other control software can be located offsite and accessed via cellular O-RAN interfaces and/or connections (e.g., the fronthaul, midhaul, backhaul, etc.). Thus, the customer premises equipment 102 can be placed at the connected environment 116 (e.g., on poles, ceilings, walls, tables, etc.) to provide coverage while the WiFi controller 122 can be located, for example, at a centralized or distributed location (e.g., at a distributed unit 126, a centralized unit 128, and/or a server computer 124). It should be understood that this example embodiment is illustrative, and therefore should not be construed as being limiting in any way.

Such embodiments also can be used to provide a pool of WiFi access points (e.g., a pool of distributed customer premises equipment 102) thereby enabling dynamic coverage, dynamic capacity, interference control, power savings by controlling the WiFi antennas using direct antenna beams, etc., as can be enabled using 5G network technologies and/or protocols. Additionally, or alternatively, software for multiple WiFi access points (e.g., multiple instances of customer premises equipment 102) can be upgraded in a centralized location (e.g., moved to a new generation of WiFi standard) without field installation at the connected environment 116. Similarly, the WiFi hardware 110 and/or the customer premises equipment 102 can be updated or upgraded without making changes to the software such as the WiFi controller 122. This can enable vendor-agnostic WiFi access points where hardware can be updated by various vendors as the WiFi controller 122 can be separate from the WiFi hardware 110. It should be understood that this example embodiment is illustrative, and therefore should not be construed as being limiting in any way.

Thus, it can be appreciated that embodiments of the concepts and technologies disclosed herein can enable decoupling of WLAN hardware and software allowing for more flexible and efficient use of resources. Embodiments also can separately enable architecture that allows placement of antenna/WiFi radios and/or WiFi access points remotely and WLAN protocols on the centralized devices or entities, thereby helping maximize the lifespan of WiFi hardware 110, and minimize WiFi hardware 110 updates and/or upgrade costs for new technology upgrades. Because the WiFi controller 122 can run on a cloud-based server computer 124 (e.g., a generic hardware platform) or other hardware platforms such as the distributed unit 126 and/or centralized unit 128, platforms can be collocated with a network operator RAN, carrier network, or other centralized location. Similarly, the distributed unit 126 and/or other entities illustrated and described herein can use edge computing technologies to enable data processing closer to the customer premises equipment 102 (and user for example), thereby potentially reducing latency and improving the performance of latency-sensitive applications. Also, automated WLAN network operation, utilizing real time data analysis, and a virtualized WLAN can help automate network management and resource allocation to better handle the cellular network offloading. It should be understood that these benefits are example benefits that may result from some embodiments of the concepts and technologies disclosed herein and should not be construed as being limiting in any way.

According to various embodiments, the concepts and technologies disclosed herein can be used to offload cellular traffic at or near the customer premises equipment 102 to a WiFi network that can be created by the customer premises equipment 102 (acting as a radio unit) and the cellular network 120, where the various entities on the cellular network 120 (e.g., the distributed unit 126, the centralized unit 128, and/or standalone WiFi controllers 122 on the WLAN or WAN or elsewhere) can control the customer premises equipment 102 and support secure and trusted communications via WiFi for users at a connected environment 116. As such, it should be understood that the WiFi communications illustrated and described herein can correspond to offloaded cellular communications (that have been moved to WiFi as illustrated and described herein). It should be understood that this example embodiment is illustrative, and therefore should not be construed as being limiting in any way.

From the description herein, it can be appreciated that the cellular network 120 can include a transport layer (e.g., including in some embodiments the fronthaul, midhaul, and backhaul, etc.), a cellular network core or backbone, a radio access network (e.g., including the customer premises equipment 102, the distributed unit 126, the centralized unit 128, etc.), and/or other components of cellular mobility networks. Furthermore, it should be understood that in some embodiments, the choice as to where to locate the WiFi controller 122 (e.g., at the distributed unit 126, the centralized unit 128, the server computer 124, or the like) can be based on geographic location, cost of transport, and/or other considerations. It should be understood that this example embodiment is illustrative, and therefore should not be construed as being limiting in any way.

FIG. 1 illustrates one customer premises equipment 102, one network 104, one user device 114, one connected environment 116, one network 120, one server computer 124, one distributed unit 126, and one centralized unit 128. It should be understood, however, that various implementations of the operating environment 100 can include one or more than one customer premises equipment 102; one or more than one network 104; zero, one, or more than one user device 114; one or more than one connected environment 116; one or more than one network 120; one or more than one server computer 124; zero, one, or more than one distributed unit 126; and zero, one, or more than one centralized unit 128. As such, the illustrated embodiment should be understood as being illustrative, and should not be construed as being limiting in any way.

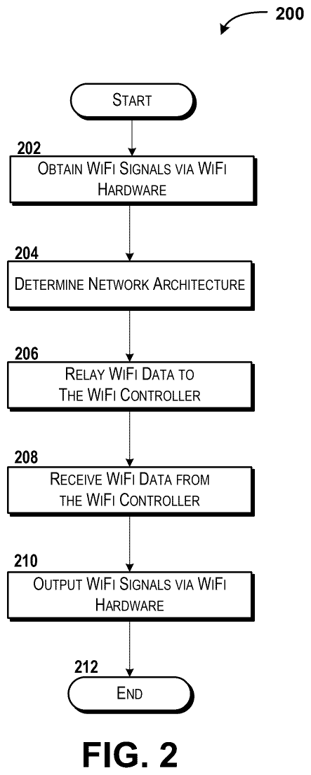

Turning now to FIG. 2, aspects of a method 200 for enabling WiFi-cellular interworking with virtualized WiFi access points will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as the customer premises equipment 102, the server computer 124, the distributed unit 126, and/or the centralized unit 128, to perform one or more operations and/or causing the processor to direct other components of the computing system or device to perform one or more of the operations.

For purposes of illustrating and describing the concepts of the present disclosure, the method 200 is described herein as being performed by the customer premises equipment 102 via execution of one or more software modules such as, for example, the radio unit controller 108. It should be understood that additional and/or alternative devices and/or network nodes can provide the functionality described herein via execution of one or more modules, applications, and/or other software including, but not limited to, the radio unit controller 108. Thus, the illustrated embodiments are illustrative, and should not be viewed as being limiting in any way.

The method 200 begins at operation 202. At operation 202, the customer premises equipment 102 can obtain WiFi signals 112 via the WiFi hardware 110. As shown in FIG. 1, the WiFi signals 112 obtained in operation 202 can be received from a user device 114 in some embodiments. It should be understood that this example embodiment is illustrative, and therefore should not be construed as being limiting in any way. As explained herein, the WiFi hardware 110 can include a WiFi receiver, transmitter, and/or transceiver as well as other hardware such as repeaters, filters, analog-to-digital translation devices, combinations thereof, or the like. Thus, operation 202 can correspond to the customer premises equipment 102 obtaining WiFi signals 112 via one or more components of the WiFi hardware 110.

From operation 202, the method 200 can proceed to operation 204. At operation 204, the customer premises equipment 102 can determine a network architecture for the cellular network 120. As explained above, the customer premises equipment 102 can store a network architecture file 130 that describes the network architecture. The network architecture file 130 can be stored locally (e.g., in a memory or other data storage device), or the network architecture file 130 can be stored remotely. In any event, the network architecture file 130 can be stored as a network map, as component of the configurations or settings for the customer premises equipment 102, or as a network file or network topology (e.g., a directed graph or the like). In some other embodiments, the customer premises equipment 102 can access a network architecture file 130 from time to time (e.g., at a service, device, or data storage location) and determine the network architecture at any time. Thus, operation 204 can correspond to the customer premises equipment 102 determining the network architecture for the cellular network 120 including, for example, where a WiFi controller 122 is located that controls the customer premises equipment 102 (e.g., at the distributed unit 126, at the centralized unit 128, at a server computer 124, or elsewhere). It should be understood that this example embodiment is illustrative, and therefore should not be construed as being limiting in any way.

From operation 204, the method 200 can proceed to operation 206. At operation 206, the customer premises equipment 102 can relay WiFi data 118 to a WiFi controller 122. Although not separately illustrated in FIG. 2, it should be understood that the customer premises equipment 102 can be configured (e.g., via execution of the radio unit controller 108) to translate the WiFi signals 112 obtained in operation 202 to WiFi data 118. After creating the WiFi data 118, the customer premises equipment 102 can be configured to transmit the WiFi data 118 to the device that controls the communications of the customer premises equipment 102 (e.g., as determined in operation 204, namely the distributed unit 126, the centralized unit 128, the server computer 124, or other location at which the WiFi controller 122 operates).

Although not illustrated in FIG. 2, it can be appreciated that the WiFi data 118 can be transmitted in operation 206 via the fronthaul, the midhaul, the backhaul, and/or other networks such as the Internet. Furthermore, it should be understood that the entity to which the WiFi data 118 is transmitted can perform operations on the WiFi data 118 such as, for example, routing the WiFi data 118 to various recipients, systems, devices, or the like; and/or obtaining and/or preparing further iterations of the WiFi data 118 for providing back to the customer premises equipment 102 for transmission. In various embodiments, the WiFi data 118 can be provided back to the customer premises equipment 102 as WiFi signal data that is ready for transmission as WiFi signals 112 by the WiFi hardware 110 of the customer premises equipment 102. It should be understood that this example embodiment is illustrative, and therefore should not be construed as being limiting in any way.

From operation 206, the method 200 can proceed to operation 208. At operation 208, the customer premises equipment 102 can receive WiFi data 118 from the WiFi controller 122. As noted above, the WiFi data 118 received in operation 208 can be received as digital data that can be translated, by the radio unit controller 108, into WiFi signals 112 in some embodiments. In some other embodiments, the WiFi data 118 received in operation 208 can be received as WiFi signal data that can be transmitted by the WiFi hardware 110 of the customer premises equipment 102 without any data translation as such. It should be understood that this example embodiment is illustrative, and therefore should not be construed as being limiting in any way.

From operation 208, the method 200 can proceed to operation 210. At operation 210, the customer premises equipment 102 can output WiFi signals 112 via the WiFi hardware 110. The WiFi signals 112 (including WiFi signals 112 received in operation 208 and/or WiFi signals 112 created based on the WiFi data 118 obtained in operation 208) can be passed to the WiFi hardware 110 for transmission. As such, it can be appreciated that the customer premises equipment 102 can receive WiFi signals 112, pass WiFi data 118 to an offsite WiFi controller 122 for various operations, receive WiFi data 118 or signals from the offsite WiFi controller 122, and transmit WiFi signals 112 all without an onboard WiFi controller 122 and/or with offsite WiFi control. According to various embodiments of the concepts and technologies disclosed herein, the WiFi signals 112 output in operation 210 can be transmitted to the user device 114 that sent the signals received in operation 202. It should be understood that this example embodiment is illustrative, and therefore should not be construed as being limiting in any way.

From operation 210, the method 200 can proceed to operation 212. The method 200 can end at operation 212.

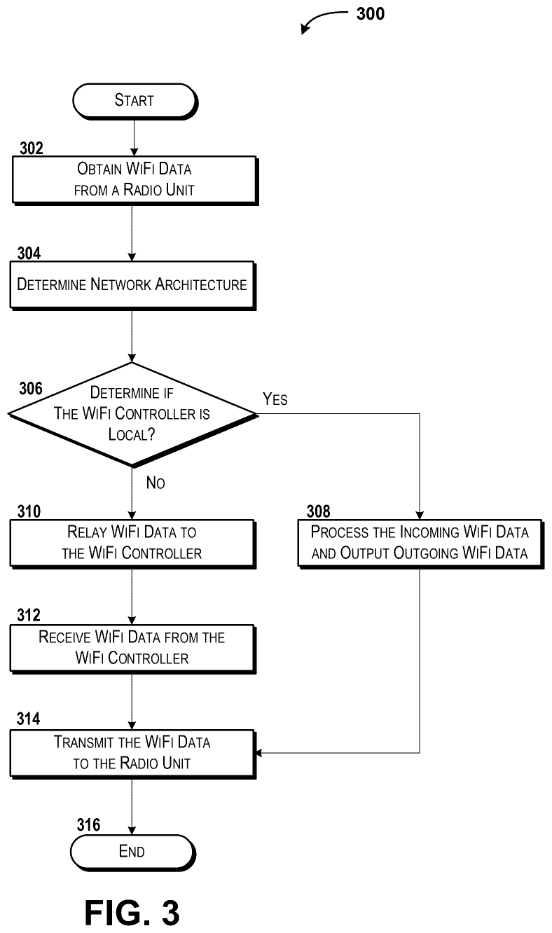

Turning now to FIG. 3, aspects of a method 300 for enabling WiFi-cellular interworking with virtualized WiFi access points will be described in detail, according to an illustrative embodiment. For purposes of illustrating and describing the concepts of the present disclosure, the method 300 is described herein as being performed by the distributed unit 126 or the centralized unit 128 via execution of one or more software modules such as, for example, the WiFi controller 122. It should be understood that additional and/or alternative devices and/or network nodes can provide the functionality described herein via execution of one or more modules, applications, and/or other software including, but not limited to, the WiFi controller 122. Thus, the illustrated embodiments are illustrative, and should not be viewed as being limiting in any way.

The method 300 begins at operation 302. At operation 302, the distributed unit 126 or the centralized unit 128 can obtain WiFi data 118 from a radio unit such as, for example, the customer premises equipment 102. As explained herein, the WiFi data 118 can be obtained from the customer premises equipment 102 via one or more portions of the cellular network 120. In embodiments in which the method 300 is performed by a distributed unit 126, the WiFi data 118 can be obtained via the fronthaul of the cellular network 120. In embodiments in which the method 300 is performed by a centralized unit 128, the WiFi data 118 can be obtained via the fronthaul and midhaul of the cellular network 120. It should be understood that that the centralized unit 128 can be configured to receive the WiFi data 118 directly from the customer premises equipment 102 and/or that the WiFi data 118 can be relayed to the centralized unit 128 by the distributed unit 126 in some embodiments. It should be understood that these example embodiments are illustrative, and therefore should not be construed as being limiting in any way.

From operation 302, the method 300 can proceed to operation 304. At operation 304, the distributed unit 126 or the centralized unit 128 can determine a network architecture for a network that includes the distributed unit 126 and/or the centralized unit 128. In some embodiments of the concepts and technologies disclosed herein, the distributed unit 126 and/or the centralized unit 128 can determine if the WiFi data 118 is to be operated on by an onboard WiFi controller 122 and/or if the WiFi data 118 is to be relayed to other entities or devices (e.g., the distributed unit 126 may be configured to relay the WiFi data 118 to the centralized unit 128 and/or the server computer 124, while the centralized unit 128 may be configured to relay the WiFi data 118 to the server computer 124 or other entities).

As explained above, the distributed unit 126 and/or the centralized unit 128 can be configured to store the network architecture file 130 locally (e.g., in a memory or other data storage device), or the network architecture file 130 that describes the network architecture can be stored remotely from the distributed unit 126 and/or the centralized unit 128. In any event, the network architecture file 130 can be stored as a network map, as a component of the configurations or settings for the distributed unit 126 and/or the centralized unit 128, or as a network file or topology. In some other embodiments, the distributed unit 126 and/or the centralized unit 128 can access a network architecture file 130 from time to time (e.g., at a service, device, or data storage location) and determine the network architecture file 130 at any time. Thus, operation 304 can correspond to the distributed unit 126 and/or the centralized unit 128 determining the network architecture for the cellular network 120 including, for example, where a WiFi controller 122 is located that controls the customer premises equipment 102 (e.g., at the distributed unit 126, at the centralized unit 128, at a server computer 124, or elsewhere). It should be understood that this example embodiment is illustrative, and therefore should not be construed as being limiting in any way.

From operation 304, the method 300 can proceed to operation 306. At operation 306, the distributed unit 126 or the centralized unit 128 can determine if the WiFi controller 122 is local (or remote). It can be appreciated that operation 306 can be performed by the distributed unit 126 and/or the centralized unit 128 based on the network architecture determined (e.g., based on the network architecture file 130) in operation 304. If the distributed unit 126 determines, for example, that the WiFi controller 122 is located at the distributed unit 126, the distributed unit 126 can determine that the WiFi controller 122 is local. If the distributed unit 126 determines, for example, that the WiFi controller 122 is located at the centralized unit 128, the server computer 124, or elsewhere, the distributed unit 126 can determine that the WiFi controller 122 is remote. Similar determinations can be made by the centralized unit 128.

If the distributed unit 126 or the centralized unit 128 determines, in operation 306, that the WiFi controller 122 is local (or is determined to not be remote), the method 300 can proceed to operation 308. At operation 308, the distributed unit 126 or the centralized unit 128 can process, via the WiFi controller 122 located locally, the incoming WiFi data 118. Various operations can be performed on the WiFi data 118 as illustrated and described herein, for example transmitting the WiFi data 118 to other devices, entities, or networks; obtaining responses from the other devices, entities, or networks; and the like. Operation 308 also can include outputting outgoing WiFi data 118. According to various embodiments of the concepts and technologies disclosed herein, the distributed unit 126 or the centralized unit 128 can be configured to output WiFi data 118 as digital data and/or to output WiFi signals 112 as illustrated and described hereinabove. Thus, operation 308 can include outputting another instance of WiFi data 118 and/or outputting WiFi signal data that is ready for transmission by the customer premises equipment 102 as WiFi signals 112. It should be understood that these example embodiments are illustrative, and therefore should not be construed as being limiting in any way.

Returning to operation 306, if the distributed unit 126 or the centralized unit 128 determines, in operation 306, that the WiFi controller 122 is not local (or is determined to be remote), the method 300 can proceed to operation 310. At operation 310, the distributed unit 126 or the centralized unit 128 can relay WiFi data 118 to the WiFi controller 122 located at the determined location, device, entity, or the like. Thus, operation 310 can include the distributed unit 126 or the centralized unit 128 relaying the WiFi data 118 to a device, entity, or network at which the WiFi controller 122 is located. Thus, for example, operation 310 can include the distributed unit 126 relaying the WiFi data 118 to the centralized unit 128 or the server computer 124 or the centralized unit 128 relaying the WiFi data 118 to the server computer 124. It should be understood that these example embodiments are illustrative, and therefore should not be construed as being limiting in any way.

Although not illustrated in FIG. 3, it can be appreciated that the WiFi data 118 can be transmitted in operation 308 via the midhaul, the backhaul, and/or other networks such as the Internet. Furthermore, it should be understood that the entity to which the WiFi data 118 is transmitted can perform operations on the WiFi data 118 such as, for example, routing the WiFi data 118 to various recipients, systems, devices, or the like; and/or obtaining and/or preparing further iterations of the WiFi data 118 for providing back to the customer premises equipment 102 for transmission. It should be understood that this example embodiment is illustrative, and therefore should not be construed as being limiting in any way.

From operation 310, the method 300 can proceed to operation 312. At operation 312, the distributed unit 126 or the centralized unit 128 can receive WiFi data 118 (or WiFi signal data) from the WiFi controller 122. In various embodiments, the WiFi data 118 can be provided back to the distributed unit 126 or the centralized unit 128 and/or therefrom to the customer premises equipment 102 as WiFi signal data that is ready for transmission as WiFi signals 112 by the WiFi hardware 110 of the customer premises equipment 102. In some other embodiments, the WiFi data 118 can be provided back to the distributed unit 126 or the centralized unit 128 as digital data. It should be understood that this example embodiment is illustrative, and therefore should not be construed as being limiting in any way.

From operation 312, the method 300 can proceed to operation 314. The method 300 also can proceed to operation 314 from operation 308. At operation 312, the distributed unit 126 or the centralized unit 128 can transmit the WiFi data 118 to the radio unit such as, for example, the customer premises equipment 102. It can be appreciated that the distributed unit 126 or the centralized unit 128 can transmit the WiFi data 118 to the radio unit such as, for example, the customer premises equipment 102 via the midhaul and/or fronthaul in various embodiments. Furthermore, it should be understood that the WiFi data 118 can be transmitted to the customer premises equipment 102 as WiFi signal data that is ready for transmission as WiFi signals 112 by the WiFi hardware 110 of the customer premises equipment 102. In some other embodiments, the WiFi data 118 can be provided back to the customer premises equipment 102 by the distributed unit 126 or the centralized unit 128 as digital data (and the customer premises equipment 102 can convert the WiFi data 118 into WiFi signals 112). It should be understood that this example embodiment is illustrative, and therefore should not be construed as being limiting in any way.

From operation 314, the method 300 can proceed to operation 316. The method 300 can end at operation 316.

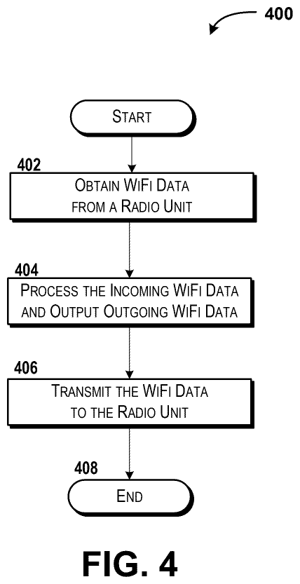

Turning now to FIG. 4, aspects of a method 400 for enabling WiFi-cellular interworking with virtualized WiFi access points will be described in detail, according to an illustrative embodiment. For purposes of illustrating and describing the concepts of the present disclosure, the method 400 is described herein as being performed by the server computer 124 via execution of one or more software modules such as, for example, the WiFi controller 122. It should be understood that additional and/or alternative devices and/or network nodes can provide the functionality described herein via execution of one or more modules, applications, and/or other software including, but not limited to, the WiFi controller 122. Thus, the illustrated embodiments are illustrative, and should not be viewed as being limiting in any way.

The method 400 begins at operation 402. At operation 402, the server computer 124 can obtain WiFi data 118 from a radio unit such as, for example, the customer premises equipment 102. As explained herein, the WiFi data 118 can be obtained from the customer premises equipment 102 via one or more portions of the cellular network 120 and/or other networks and/or network connections. In particular, the WiFi data 118 can be obtained by the server computer 124 via the fronthaul of the cellular network 120, the midhaul of the cellular network 120, the backhaul of the cellular network 120, other networks such as the Internet or a corporate network, combinations thereof, or the like. It should be understood that that the server computer 124 can be configured to receive the WiFi data 118 directly from the customer premises equipment 102 and/or that the WiFi data 118 can be relayed to the server computer 124 by multiple devices in the cellular network 120 (e.g., the distributed unit 126 and/or the centralized unit 128) and/or other devices or entities on other networks such as servers, or the like. It should be understood that these example embodiments are illustrative, and therefore should not be construed as being limiting in any way.

From operation 402, the method 400 can proceed to operation 404. At operation 404, the server computer 124 can process (e.g., via the WiFi controller 122 located locally), the incoming WiFi data 118. The server computer 124 can perform various operations on the incoming WiFi data 118 as illustrated and described herein, for example transmitting the WiFi data 118 to other devices, entities, or networks; obtaining responses from the other devices, entities, or networks; and the like. Operation 404 also can include the server computer 124 outputting outgoing WiFi data 118. According to various embodiments of the concepts and technologies disclosed herein, the server computer 124 can be configured to output WiFi data 118 as digital data and/or to output WiFi signals 112 as illustrated and described hereinabove. Thus, operation 404 can include outputting another instance of WiFi data 118 and/or outputting WiFi signal data that is ready for transmission by the customer premises equipment 102 as WiFi signals 112. It should be understood that these example embodiments are illustrative, and therefore should not be construed as being limiting in any way.

From operation 404, the method 400 can proceed to operation 406. At operation 406, the server computer 124 can transmit the WiFi data 118 to the radio unit such as, for example, the customer premises equipment 102. It can be appreciated that the server computer 124 can transmit the WiFi data 118 to the radio unit such as, for example, the customer premises equipment 102, via a network such as the Internet, the backhaul of the cellular network 120, the midhaul of the cellular network 120, the fronthaul of the cellular network 120, and/or various devices operating on these portions of networks and/or the cellular network 120 such as, for example, servers, the centralized unit 128, and/or the distributed unit 126, in various embodiments. Furthermore, it should be understood that the WiFi data 118 can be transmitted to the customer premises equipment 102 as WiFi signal data that is ready for transmission as WiFi signals 112 by the WiFi hardware 110 of the customer premises equipment 102. In some other embodiments, the WiFi data 118 can be provided back to the customer premises equipment 102 by the server computer 124 as digital data (and the customer premises equipment 102 can convert the WiFi data 118 into WiFi signals 112). It should be understood that this example embodiment is illustrative, and therefore should not be construed as being limiting in any way.

From operation 406, the method 400 can proceed to operation 408. The method 400 can end at operation 408.

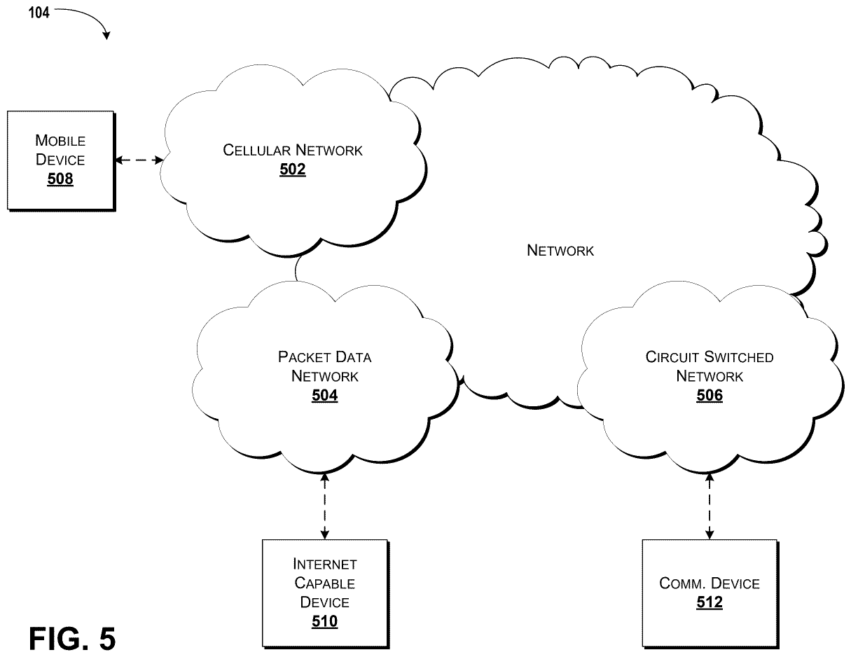

Turning now to FIG. 5, additional details of the network 104 are illustrated, according to an illustrative embodiment. The network 104 includes a cellular network 502, a packet data network 504, for example, the Internet, and a circuit switched network 506, for example, a publicly switched telephone network (“PSTN”). The cellular network 502 includes various components such as, but not limited to, base transceiver stations (“BTSs”), NodeB's or eNodeB's (“eNBs”), gNodeBs (“gNBs”), or the like; base station controllers (“BSCs”) radio network controllers (“RNCs”), or the like; an evolved packet core (“EPC”); mobile switching centers (“MSCs” or “MSSs”); session management functions (“SMFs); mobile management entities (“MMEs”); access and mobility management functions (“AMFs); authentication server functions (“AUSFs”), network slice selection functions (“NSSFs); network exposure functions (“NEFs”); policy control functions (“PCFs”); and various other functions in the user and control planes such as, for example, user plane functions (“UPFs), application functions (“AFs”), NF repository functions (“NRFs”), and the like; short message service centers (“SMSCs”); multimedia messaging service centers (“MMSCs”); home location registers (“HLRs”); home subscriber servers (“HSSs”); visitor location registers (“VLRs”); charging platforms; billing platforms; voicemail platforms; GPRS core network components; links to data networks (“DNs”) and/or other operator services, third party services, and/or the Internet; location service nodes, an IP Multimedia Subsystem (“IMS”); and the like. Of course, the cellular network 502 also can include various interfaces between various components, as is generally understood. The cellular network 502 also includes radios and nodes for receiving and transmitting voice, data, and combinations thereof to and from radio transceivers, networks, the packet data network 504, and the circuit switched network 506.

A mobile communications device 508, such as, for example, a cellular telephone, a user equipment, a mobile terminal, a PDA, a laptop computer, a handheld computer, and combinations thereof, can be operatively connected to the cellular network 502. The cellular network 502 can be configured as a 2G GSM network and can provide data communications via GPRS and/or EDGE. Additionally, or alternatively, the cellular network 502 can be configured as a 3G UMTS network and can provide data communications via the HSPA protocol family, for example, HSDPA, EUL (also referred to as HSUPA), and HSPA+. The cellular network 502 also is compatible with 4G mobile communications standards, 5G mobile communications standards, 6G mobile communication standards, other mobile communications standards, and evolved and future mobile communications standards. Moreover, the cellular network 502 may facilitate communications over various channel access methods (which may or may not be used by the aforementioned standards) including, but not limited to, TDMA, FDMA, W-CDMA, OFDM, SDMA, and the like. In addition, the cellular network 502 may facilitate data communications using GPRS, EDGE, the HSPA protocol family including HSDPA, EUL or otherwise termed HSUPA, HSPA+, and various other current and future wireless data access standards. Because additional and/or alternative mobile communications standards may be used in accordance with various embodiments of the concepts and technologies disclosed herein, it should be understood that these example embodiments are illustrative, and therefore should not be construed as being limiting in any way.

The packet data network 504 includes various devices, for example, servers, computers, databases, and other devices in communication with one another, as is generally known. The packet data network 504 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 504 includes or is in communication with the Internet. The circuit switched network 506 includes various hardware and software for providing circuit switched communications. The circuit switched network 506 may include, or may be, what is often referred to as a plain old telephone system (POTS). The functionality of a circuit switched network 506 or other circuit-switched network are generally known and will not be described herein in detail.

The illustrated cellular network 502 is shown in communication with the packet data network 504 and a circuit switched network 506, though it should be appreciated that this is not necessarily the case. One or more Internet-capable devices 510, for example, a PC, a laptop, a portable device, or another suitable device, can communicate with one or more cellular networks 502, and devices connected thereto, through the packet data network 504. It also should be appreciated that the Internet-capable device 510 can communicate with the packet data network 504 through the circuit switched network 506, the cellular network 502, and/or via other networks (not illustrated).

As illustrated, a communications device 512, for example, a telephone, facsimile machine, modem, computer, or the like, can be in communication with the circuit switched network 506, and therethrough to the packet data network 504 and/or the cellular network 502. It should be appreciated that the communications device 512 can be an Internet-capable device, and can be substantially similar to the Internet-capable device 510. In the specification, the network 104 is used to refer broadly to any combination of the networks 502, 504, 506. It should be appreciated that substantially all of the functionality described with reference to the network 104 can be performed by the cellular network 502, the packet data network 504, and/or the circuit switched network 506, alone or in combination with other networks, network elements, and the like.

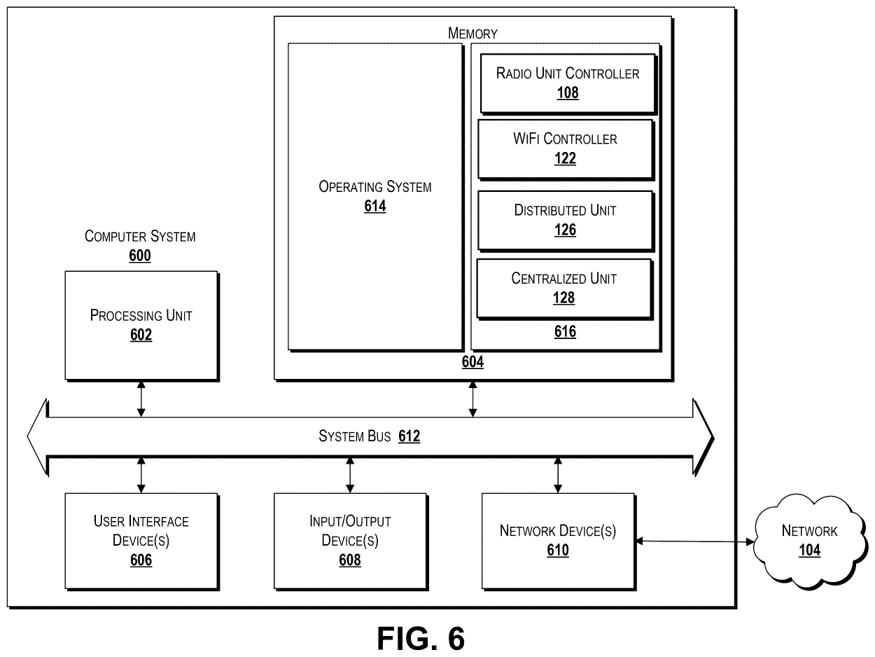

FIG. 6 is a block diagram illustrating a computer system 600 configured to provide the functionality described herein for enabling WiFi-cellular interworking with virtualized WiFi access points, in accordance with various embodiments of the concepts and technologies disclosed herein. The computer system 600 includes a processing unit 602, a memory 604, one or more user interface devices 606, one or more input/output (“I/O”) devices 608, and one or more network devices 610, each of which is operatively connected to a system bus 612. The system bus 612 can enable bi-directional communication between the processing unit 602, the memory 604, the user interface devices 606, the I/O devices 608, and the network devices 610.

The processing unit 602 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 604 communicates with the processing unit 602 via the system bus 612. In some embodiments, the memory 604 is operatively connected to a memory controller (not shown) that enables communication with the processing unit 602 via the system bus 612. The memory 604 includes an operating system 614 and one or more program modules 616. The operating system 614 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or SONOMA families of operating systems from APPLE CORPORATION, the FREEBSD family of operating systems, the SOLARIS family of operating systems from ORACLE CORPORATION, other operating systems, and the like.

The program modules 616 may include various software and/or program modules described herein. In some embodiments, for example, the program modules 616 include the radio unit controller 108, the WiFi controller 122, control software for the distributed unit 126, control software for the centralized unit 128, or other programs. These and/or other programs can be embodied in computer-readable media containing instructions that, when executed by the processing unit 602, perform one or more of the methods 200, 300, and 400 described in detail above with respect to FIGS. 2-4 and/or other functionality as illustrated and described herein. It can be appreciated that, at least by virtue of the instructions embodying the methods 200, 300, 400, and/or other functionality illustrated and described herein being stored in the memory 604 and/or accessed and/or executed by the processing unit 602, the computer system 600 is a special-purpose computing system that can facilitate providing the functionality illustrated and described herein. According to embodiments, the program modules 616 may be embodied in hardware, software, firmware, or any combination thereof. Although not shown in FIG. 6, it should be understood that the memory 604 also can be configured to store the WiFi data 118, WiFi signals 112, network architecture files 130, and/or other data, if desired.

By way of example, and not limitation, computer-readable media may include any available computer storage media or communication media that can be accessed by the computer system 600. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Computer storage media includes only non-transitory embodiments of computer readable media as illustrated and described herein. Thus, computer storage media can include volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 600. In the claims, the phrase “computer storage medium” and variations thereof does not include waves or signals per se and/or communication media.

The user interface devices 606 may include one or more devices with which a user accesses the computer system 600. The user interface devices 606 may include, but are not limited to, computers, servers, personal digital assistants, cellular phones, or any suitable computing devices. The I/O devices 608 enable a user to interface with the program modules 616. In one embodiment, the I/O devices 608 are operatively connected to an I/O controller (not shown) that enables communication with the processing unit 602 via the system bus 612. The I/O devices 608 may include one or more input devices, such as, but not limited to, a keyboard, a mouse, or an electronic stylus. Further, the I/O devices 608 may include one or more output devices, such as, but not limited to, a display screen or a printer.

The network devices 610 enable the computer system 600 to communicate with other networks or remote systems via a network, such as the network 104. Examples of the network devices 610 include, but are not limited to, a modem, a radio frequency (“RF”) or infrared (“IR”) transceiver, a telephonic interface, a bridge, a router, or a network card. The network 104 may include a wireless network such as, but not limited to, a WLAN such as a WI-FI network, a Wireless Wide Area Network (“WWAN”), a Wireless Personal Area Network (“WPAN”) such as BLUETOOTH, a Wireless Metropolitan Area Network (“WMAN”) such as a WiMAX network, or a cellular network. Alternatively, the network 104 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

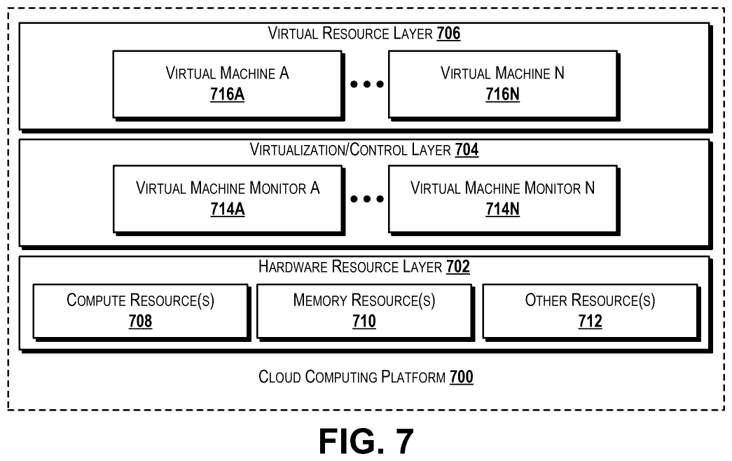

FIG. 7 illustrates an illustrative architecture for a cloud computing platform 700 that can be capable of executing the software components described herein for enabling WiFi-cellular interworking with virtualized WiFi access points. Thus, it can be appreciated that in some embodiments of the concepts and technologies disclosed herein, the cloud computing platform 700 illustrated in FIG. 7 can be used to provide the functionality described herein with respect to the customer premises equipment 102, the distributed unit 126, the centralized unit 128, and/or the server computer 124.

The cloud computing platform 700 thus may be utilized to execute any aspects of the software components presented herein. Thus, according to various embodiments of the concepts and technologies disclosed herein, the radio unit controller 108, the WiFi controller 122, control programs for the distributed unit 126, control programs for the centralized unit 128, and/or the like can be implemented, at least in part, on or by elements included in the cloud computing platform 700 illustrated and described herein. Those skilled in the art will appreciate that the illustrated cloud computing platform 700 is a simplification of but only one possible implementation of an illustrative cloud computing platform, and as such, the illustrated cloud computing platform 700 should not be construed as being limiting in any way.

In the illustrated embodiment, the cloud computing platform 700 can include a hardware resource layer 702, a virtualization/control layer 704, and a virtual resource layer 706. These layers and/or other layers can be configured to cooperate with each other and/or other elements of a cloud computing platform 700 to perform operations as will be described in detail herein. While connections are shown between some of the components illustrated in FIG. 7, it should be understood that some, none, or all of the components illustrated in FIG. 7 can be configured to interact with one another to carry out various functions described herein. In some embodiments, the components are arranged so as to communicate via one or more networks such as, for example, the network 104 illustrated and described hereinabove (not shown in FIG. 7). Thus, it should be understood that FIG. 7 and the following description are intended to provide a general understanding of a suitable environment in which various aspects of embodiments can be implemented, and should not be construed as being limiting in any way.

The hardware resource layer 702 can provide hardware resources. In the illustrated embodiment, the hardware resources can include one or more compute resources 708, one or more memory resources 710, and one or more other resources 712. The compute resource(s) 708 can include one or more hardware components that can perform computations to process data, and/or to execute computer-executable instructions of one or more application programs, operating systems, services, and/or other software including, but not limited to, the radio unit controller 108 and/or the WiFi controller 122 illustrated and described herein.

According to various embodiments, the compute resources 708 can include one or more central processing units (“CPUs”). The CPUs can be configured with one or more processing cores. In some embodiments, the compute resources 708 can include one or more graphics processing units (“GPUs”). The GPUs can be configured to accelerate operations performed by one or more CPUs, and/or to perform computations to process data, and/or to execute computer-executable instructions of one or more application programs, operating systems, and/or other software that may or may not include instructions that are specifically graphics computations and/or related to graphics computations. In some embodiments, the compute resources 708 can include one or more discrete GPUs. In some other embodiments, the compute resources 708 can include one or more CPU and/or GPU components that can be configured in accordance with a co-processing CPU/GPU computing model. Thus, it can be appreciated that in some embodiments of the compute resources 708, a sequential part of an application can execute on a CPU and a computationally-intensive part of the application can be accelerated by the GPU. It should be understood that this example is illustrative, and therefore should not be construed as being limiting in any way.

In some embodiments, the compute resources 708 also can include one or more system on a chip (“SoC”) components. It should be understood that an SoC component can operate in association with one or more other components as illustrated and described herein, for example, one or more of the memory resources 710 and/or one or more of the other resources 712. In some embodiments in which an SoC component is included, the compute resources 708 can be or can include one or more embodiments of the SNAPDRAGON brand family of SoCs, available from QUALCOMM of San Diego, California; one or more embodiment of the TEGRA brand family of SoCs, available from NVIDIA of Santa Clara, California; one or more embodiment of the HUMMINGBIRD brand family of SoCs, available from SAMSUNG of Seoul, South Korea; one or more embodiment of the Open Multimedia Application Platform (“OMAP”) family of SoCs, available from TEXAS INSTRUMENTS of Dallas, Texas; one or more customized versions of any of the above SoCs; and/or one or more other brand and/or one or more proprietary SoCs.

The compute resources 708 can be or can include one or more hardware components arranged in accordance with an ARM architecture, available for license from ARM HOLDINGS of Cambridge, United Kingdom. Alternatively, the compute resources 708 can be or can include one or more hardware components arranged in accordance with an x86 architecture, such as an architecture available from INTEL CORPORATION of Mountain View, California, and others. Those skilled in the art will appreciate the implementation of the compute resources 708 can utilize various computation architectures and/or processing architectures. As such, the various example embodiments of the compute resources 708 as mentioned hereinabove should not be construed as being limiting in any way. Rather, implementations of embodiments of the concepts and technologies disclosed herein can be implemented using compute resources 708 having any of the particular computation architecture and/or combination of computation architectures mentioned herein as well as other architectures.

Although not separately illustrated in FIG. 7, it should be understood that the compute resources 708 illustrated and described herein can host and/or execute various services, applications, portals, and/or other functionality illustrated and described herein. Thus, the compute resources 708 can host and/or can execute the radio unit controller 108, the WiFi controller 122, or other applications or services illustrated and described herein.

The memory resource(s) 710 can include one or more hardware components that can perform or provide storage operations, including temporary and/or permanent storage operations. In some embodiments, the memory resource(s) 710 can include volatile and/or non-volatile memory implemented in any method or technology for storage of information such as computer-readable instructions, data structures, program modules, or other data disclosed herein. Computer storage media is defined hereinabove and therefore should be understood as including, in various embodiments, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium that can be used to store data and that can be accessed by the compute resources 708, subject to the definition of “computer storage media” provided above (e.g., as excluding waves and signals per se and/or communication media as defined in this application).

Although not illustrated in FIG. 7, it should be understood that the memory resources 710 can host or store the various data illustrated and described herein including, but not limited to, WiFi signals 112, the WiFi data 118, the network architecture file 130, and/or other data, if desired. It should be understood that this example is illustrative, and therefore should not be construed as being limiting in any way.

The other resource(s) 712 can include any other hardware resources that can be utilized by the compute resources(s) 708 and/or the memory resource(s) 710 to perform operations. The other resource(s) 712 can include one or more input and/or output processors (e.g., a network interface controller and/or a wireless radio), one or more modems, one or more codec chipsets, one or more pipeline processors, one or more fast Fourier transform (“FFT”) processors, one or more digital signal processors (“DSPs”), one or more speech synthesizers, combinations thereof, or the like.

The hardware resources operating within the hardware resource layer 702 can be virtualized by one or more virtual machine monitors (“VMMs”) 714A-714N (also known as “hypervisors;” hereinafter “VMMs 714”). The VMMs 714 can operate within the virtualization/control layer 704 to manage one or more virtual resources that can reside in the virtual resource layer 706. The VMMs 714 can be or can include software, firmware, and/or hardware that alone or in combination with other software, firmware, and/or hardware, can manage one or more virtual resources operating within the virtual resource layer 706.

The virtual resources operating within the virtual resource layer 706 can include abstractions of at least a portion of the compute resources 708, the memory resources 710, the other resources 712, or any combination thereof. These abstractions are referred to herein as virtual machines (“VMs”). In the illustrated embodiment, the virtual resource layer 706 includes VMs 716A-716N (hereinafter “VMs 716”).

Based on the foregoing, it should be appreciated that systems and methods for enabling WiFi-cellular interworking with virtualized WiFi access points have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A system comprising:
a processor; and
a memory that stores computer-executable instructions that, when executed by the processor, cause the processor to perform operations comprising
receiving, via a fronthaul of a cellular network and from a customer premises equipment comprising a WiFi transceiver, WiFi data generated by the customer premises equipment based on WiFi signals received at the customer premises equipment,
determining, based on a network architecture file, a WiFi controller that is configured to control the customer premises equipment, wherein the WiFi controller is not located at the customer premises equipment,
relaying the WiFi data to the WiFi controller, wherein the WiFi controller performs an operation on the WiFi data and creates another instance of WiFi data,
receiving, from the WiFi controller, the other instance of WiFi data, and
providing, to the customer premises equipment, the other instance of WiFi data, wherein the customer premises equipment transmits WiFi signals at the customer premises equipment based on the WiFi data.

2. The system of claim 1, wherein the WiFi data is received at a distributed unit of the cellular network, wherein the WiFi controller is executed by the distributed unit, and wherein the distributed unit manages operations of the customer premises equipment.

3. The system of claim 1, wherein receiving the WiFi data further comprises receiving the WiFi data via a midhaul of the cellular network, wherein the WiFi data is received at a centralized unit of the cellular network, wherein the WiFi data is relayed to the centralized unit of the cellular network by a distributed unit of the cellular network, and wherein the WiFi controller is executed by the centralized unit.

4. The system of claim 1, wherein receiving the WiFi data further comprises receiving the WiFi data via a midhaul of the cellular network, a backhaul of the cellular network, and a wide area network, wherein the WiFi data is received at a server computer operating on the wide area network, wherein the WiFi data is relayed to the server computer via a distributed unit of the cellular network and via a centralized unit of the cellular network, and wherein the WiFi controller is executed by the server computer.

5. The system of claim 4, wherein the backhaul is configured to use a 3rd generation partnership project (“3GPP”) standard for trusted access between the centralized location and the server computer.

6. The system of claim 4, wherein an interface of the fronthaul is enhanced to support WiFi access, and wherein a further interface of the midhaul is enhanced to support the WiFi access.

7. The system of claim 1, wherein the customer premises equipment executes a radio unit controller that translates the WiFi signals into the WiFi data and the other instance of WiFi data into the other instance of WiFi signals.

8. A method comprising:
receiving, at a computer comprising a processor, via a fronthaul of a cellular network, and from a customer premises equipment comprising a WiFi transceiver, WiFi data generated by the customer premises equipment based on WiFi signals received at the customer premises equipment;
determining, by the processor and based on a network architecture file, a WiFi controller that is configured to control the customer premises equipment, wherein the WiFi controller is not located at the customer premises equipment;
relaying, by the processor and to the WiFi controller, the WiFi data, wherein the WiFi controller performs an operation on the WiFi data and creates another instance of WiFi data;
receiving, by the processor and from the WiFi controller, the other instance of WiFi data; and
providing, by the processor and to the customer premises equipment, the other instance of WiFi data, wherein the customer premises equipment transmits WiFi signals at the customer premises equipment based on the WiFi data.

9. The method of claim 8, wherein the WiFi data is received at a distributed unit of the cellular network, wherein the WiFi controller is executed by the distributed unit, and wherein the distributed unit manages operations of the customer premises equipment.

10. The method of claim 8, wherein receiving the WiFi data further comprises receiving the WiFi data via a midhaul of the cellular network, wherein the WiFi data is received at a centralized unit of the cellular network, wherein the WiFi data is relayed to the centralized unit of the cellular network by a distributed unit of the cellular network, and wherein the WiFi controller is executed by the centralized unit.

11. The method of claim 8, wherein receiving the WiFi data further comprises receiving the WiFi data via a midhaul of the cellular network, a backhaul of the cellular network, and a wide area network, wherein the WiFi data is received at a server computer operating on the wide area network, wherein the WiFi data is relayed to the server computer via a distributed unit of the cellular network and via a centralized unit of the cellular network, and wherein the WiFi controller is executed by the server computer.

12. The method of claim 11, wherein the backhaul is configured to use a 3rd generation partnership project (“3GPP”) standard for trusted access between the centralized location and the server computer.

13. The method of claim 8, wherein the customer premises equipment executes a radio unit controller that translates the WiFi signals into the WiFi data and the other instance of WiFi data into the other instance of WiFi signals.

14. A computer storage medium having computer-executable instructions stored thereon that, when executed by a processor, cause the processor to perform operations comprising:
receiving, via a fronthaul of a cellular network and from a customer premises equipment, WiFi data generated by the customer premises equipment based on WiFi signals received at the customer premises equipment;
determining, based on a network architecture file, a WiFi controller that is configured to control the customer premises equipment, wherein the WiFi controller is not located at the customer premises equipment;
relaying the WiFi data to the WiFi controller, wherein the WiFi controller performs an operation on the WiFi data and creates another instance of WiFi data;
receiving, from the WiFi controller, the other instance of WiFi data; and
providing, to the customer premises equipment, the other instance of WiFi data, wherein the customer premises equipment transmits WiFi signals at the customer premises equipment based on the WiFi data.

15. The computer storage medium of claim 14, wherein the WiFi data is received at a distributed unit of the cellular network, wherein the WiFi controller is executed by the distributed unit, and wherein the distributed unit manages operations of the customer premises equipment.

16. The computer storage medium of claim 14, wherein receiving the WiFi data further comprises receiving the WiFi data via a midhaul of the cellular network, wherein the WiFi data is received at a centralized unit of the cellular network, wherein the WiFi data is relayed to the centralized unit of the cellular network by a distributed unit of the cellular network, and wherein the WiFi controller is executed by the centralized unit.

17. The computer storage medium of claim 14, wherein receiving the WiFi data further comprises receiving the WiFi data via a midhaul of the cellular network, a backhaul of the cellular network, and a wide area network, wherein the WiFi data is received at a server computer operating on the wide area network, wherein the WiFi data is relayed to the server computer via a distributed unit of the cellular network and via a centralized unit of the cellular network, and wherein the WiFi controller is executed by the server computer.

18. The computer storage medium of claim 17, wherein the backhaul is configured to use a 3rd generation partnership project (“3GPP”) standard for trusted access between the centralized location and the server computer.

19. The computer storage medium of claim 17, wherein an interface of the fronthaul is enhanced to support WiFi access, and wherein a further interface of the midhaul is enhanced to support the WiFi access.

20. The computer storage medium of claim 14, wherein the customer premises equipment executes a radio unit controller that translates the WiFi signals into the WiFi data and the other instance of WiFi data into the other instance of WiFi signals.
